(19) United States
(12) Patent Application Publication
(10) Pub. No.: US 2008/0264968 A1
(43) Pub. Date: Oct. 30, 2008

(54) Delivery Element for Delivery a Plurality of Unsorted Products to a Subsequent Apparatus

(76) Inventor: Michael Jurs, Haffkrug (DE)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/814,970

(22) PCT Filed: Jan. 26, 2006
(86) PCT No.: PCT/EP2006/000853

§ 371 Date: Apr. 4, 2008

(30) Foreign Application Priority Data
Jan. 28, 2005 (DE) 10 2005 004 750.5

(51) Int. Cl. B65G 47/14

(52) U.S. Cl. 221/289

(57) ABSTRACT

The invention concerns a delivery element for delivering a plurality of unsorted products to a subsequent apparatus, in particular an apparatus for separating the products, including a rotatably driveable turntable with which is associated a guide element arranged eccentrically to the turntables, which is distinguished by the fact that the guide element comprises a side wall which runs approximately parallel to a radially peripheral side wall extending perpendicularly from the turntable, both the turntable and the guide element being driven optionally in the same or opposite directions.

The invention concerns a delivery element for delivering a plurality of unsorted products to a subsequent apparatus, in particular an apparatus for separating the products, including a rotatably driveable turntable with which is associated a guide element arranged eccentrically to the turntable.

Apparatuses of this kind are used in many fields in particular in the packaging and foodstuffs industry. It is precisely in these fields that it is necessary to separate individual products or groups of products from a large reservoir, in particular a product stream consisting of a plurality of random products. It is known that products are taken manually from a random incoming stream, separated and then delivered for subsequent processing or packaging. In the course of automation, handling systems which automatically separate the products are being used more and more frequently. In order to simplify and improve delivery to the apparatuses for separation, to an increasing extent the above-mentioned turntables or storage tables are used, which are supplied with a random incoming stream of products, for example fish fillets or the like, and move them by rotation continuously or intermittently into the region of the handling elements for separation.

Such turntables, however, have the drawback that the products on the turntable are frequently unevenly distributed over the whole surface of the turntable. As a result, again and again it happens that individual products lie in so-called dead areas, that is, areas which are not reached by any of the handling elements. This leads to such products rotating endlessly without being picked up by one of the gripping or suction elements of the handling elements. Furthermore, it is a disadvantage that the handling elements have to search for products over a large area, namely the whole of the table surface, which requires a large operating radius of the handling elements and leads to long transport distances.

It is therefore the object of the present invention to provide a simple and reliable apparatus for evening out random products and delivering them in a focused way.

This object is achieved by an apparatus with the features mentioned hereinbefore by the fact that the guide element comprises a side wall which runs approximately parallel to a radially peripheral side wall extending perpendicularly from the turntable, both the turntable and the guide element being driven optionally in the same or opposite directions. As a result, the products are forced along the radially peripheral and hence closed side wall of the turntable into a linear arrangement on the turntable, which essentially simplifies receipt and separation of the products. Due to the side wall of the guide element, which runs parallel to the side wall of the turntable and which at the same time is the outer wall of the guide element, the products can be forced safely and reliably outwards into the region of a product removal region. The perpendicular design of the side wall as well as the active driving of turntable on the one hand and guide element on the other hand also prevent products from catching on the guide element, so that trouble-free delivery of the products from the product feed region to the product removal region is ensured.

In a preferred development of the invention, the guide element is adjustably attached to the support. Hence a desired product width can easily be set. To put it another way, the width of the product removal region can be adapted to different product widths.

Further advantageous features and preferred embodiments are apparent from the subsidiary claims and the description. A particularly preferred embodiment is described in more detail with reference to the attached drawings. The drawings show:

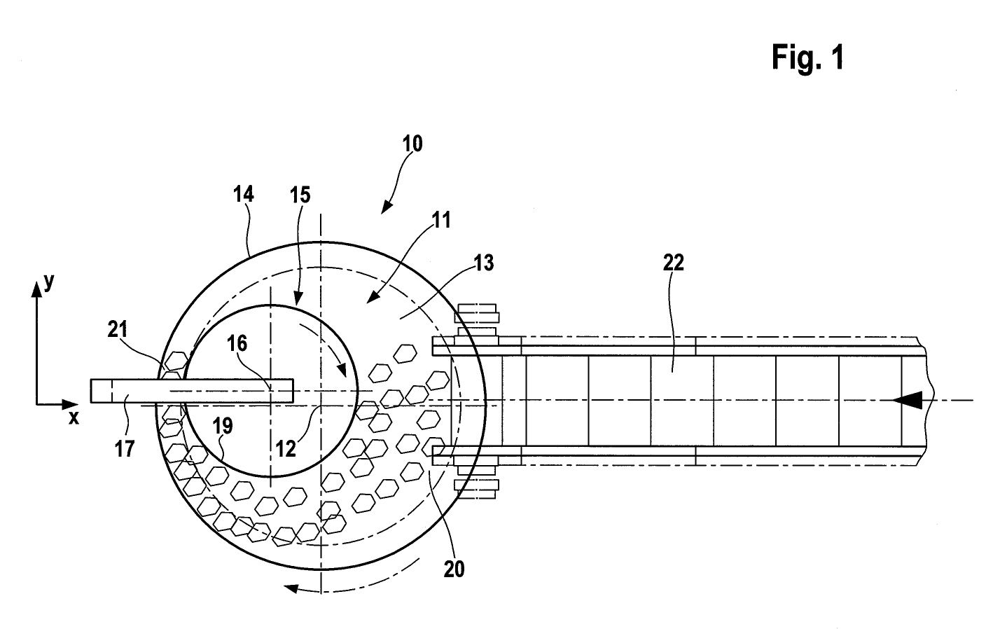

FIG. 1 a top view of a turntable with eccentrically arranged guide element, and

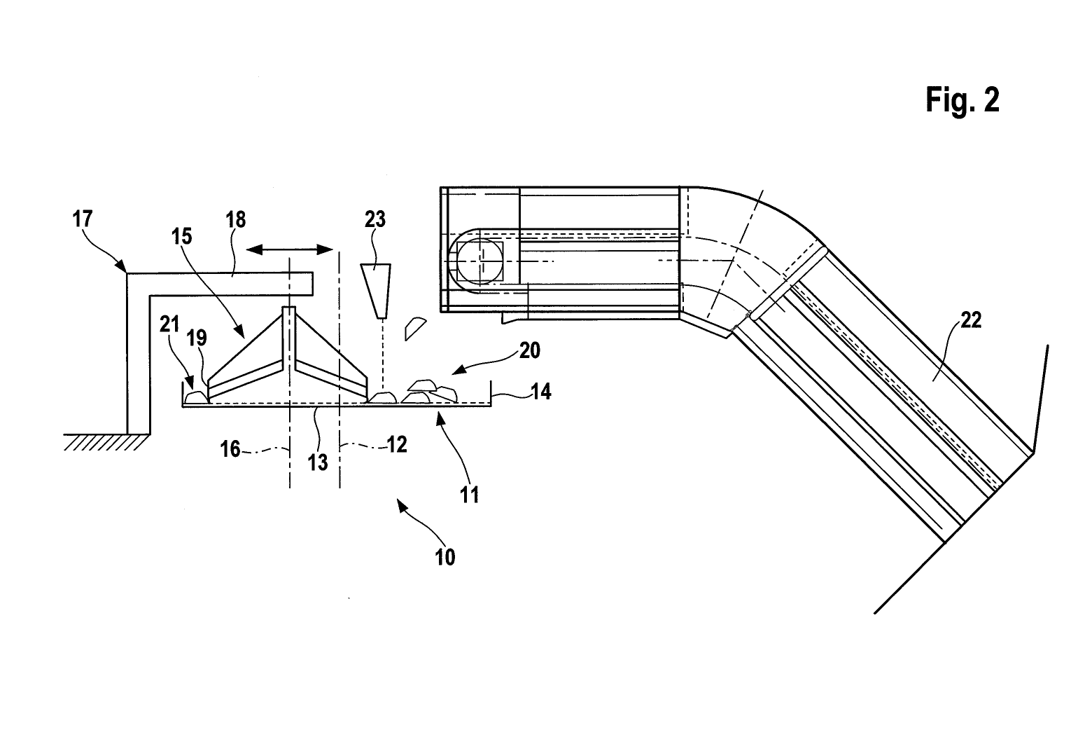

FIG. 2 a side view of the apparatus as in FIG. 1.

The apparatus shown serves to even out and deliver a plurality of unsorted products, in particular fish fillets, to a subsequent apparatus for processing and/or packaging them.

The delivery element 10 according to FIG. 1 includes a turntable 11 which is rotatable about a rotary shaft 12. The turntable 11 is designed as a circular disc 13 and provided, radially all round, with a side wall 14 extending perpendicularly from the disc 13. The rotary shaft 12 is usually oriented perpendicularly to the disc 13, the disc 13 preferably being oriented horizontally. Alternatively, the unit consisting of disc 13 and rotary shaft can be inclined. The rotary shaft 12 runs centrally to the disc 13.

In the region of the turntable 11 is arranged a guide element 15. The guide element 15 is arranged eccentrically to the turntable 11 and rotatable about a rotary shaft 16. The guide element 15 is arranged on the side of the turntable 11 which receives the products, and optionally rests on the turntable 11 or is arranged above the turntable 11 a short distance from it. The guide element 15 is rotatably attached to a support 17, for example an angular supporting arm, the support 17 being stationarily attached to a frame (not shown) or to the floor. The rotary shaft 16 of the guide element 15 is offset from the rotary shaft 12 of the turntable 11. The rotary shafts 12, 16, however, run essentially parallel to each other. The offset of the rotary shafts 12, 16 exists in the embodiment shown by an amount in the X direction and the Y direction.

Preferably, the rotary shaft 16 of the guide element 15, which is also referred to as an eccentric shaft, is adjustable. The adjustability of the eccentric shaft can be effected in various ways. For instance, the rotary shaft 16 can be slidable in an oblong hole (not shown) in an arm 18 of the support 17 and fixable in the desired position by screws or the like. Another possibility lies in that the arm 18 itself is e.g. telescopic. Other common adjustment mechanisms can be used too.

The guide element 15 in the embodiment shown has a preferably circular side wall 19 which runs approximately parallel to the side wall 14 of the turntable 11. Other forms and shapes of the side wall 19, e.g. oval or polygonal designs, can be used too. The diameter of the guide element 15 is smaller than the diameter of the turntable 11, so that the guide element 15 covers only part of the turntable 11. The region of the turntable 11 which is covered or surrounded by the guide element 15 is always free from products. Outside the guide element 11, that is, on the side of the side wall 19 facing away from the rotary shaft 16, is formed the surface for the products. Due to the eccentricity of the guide element 15 in relation to the turntable 11, the guide element 15 divides the turntable 11 or the surface provided for the products into a product feed region 20 and a product removal region 21. This also results in the product feed region 20 being sickle-shaped. This sickle-shaped product feed region 20 is free from interfering contours, so that easy filling of this region with products is ensured.

By adjustment of the eccentricity of the guide element 15, the sizes of the respective regions (product feed region 20 and product removal region 21) are variable, the product feed region 20 usually being larger than the product removal region 21. Further, the product removal region 21 extends in a ring at the outer edge of the turntable 11 concentrically round the rotary shaft 12. The product feed region 20 corresponds to the area lying within the product removal region 21 minus the area covered or surrounded by the guide element 15, and is sickle-shaped.

The delivery element 11 in the embodiment shown can be supplied via a delivery belt 22 with a product stream of random and unsorted products. Instead of the delivery belt 22, other conveying or transport elements, e.g. chutes or the like, can be used. The delivery belt 22 preferably leads in the product feed region 20 into or onto the delivery element 10. In the region of the product feed region 20, preferably above it, is arranged a level sensor 23. The information or signals determined by the level sensor 23 can be processed by means of a control system to which the delivery element 10 can be connected. Preferably, the delivery belt and any subsequent apparatuses are also connected to this control system. In addition, further monitoring elements can be provided for the product removal region 21 and operatively connected to the control system.

In the embodiment shown, the directions of rotation of the turntable 11 and guide element 15 are the same. However, there is also the possibility of driving in opposite directions. Furthermore, the guide element 15 can also be stationary relative to the rotating turntable 11, so that a relative speed exists between the turntable 11 on the one hand and the guide element 15 on the other hand. Similarly, driving of the guide element 15 by friction-locking with the delivery element 11 is possible.

Such apparatuses 10 can be connected to different systems. Use in combination with an apparatus for the weight-controlled assembly of products into a lot is preferred. The apparatus 10 may however also be connected to other apparatuses. Also, products or objects already sorted or presorted by means of the apparatus 10 can be delivered for further processing or to a packaging unit. The shape of the guide element 15 is also not confined to the circular shape, but can have any other shapes, e.g. an oval, a polygon or the like.

Below, the principle of the method of the delivery element 10 is described in more detail. The turntable 11 is intermittently or continuously supplied with a product stream by the delivery belt 22. The products drop in the region of the product feed region 20 onto the turntable 11. The latter rotates about the rotary shaft 12. Due to the guide element 15 also rotating or its side wall 19, the products are forced outwards out of the product feed region 20 into the product removal region 21, so that products evened out in a line, as it were, rotate on the turntable 11, which can then be reliably separated by suction, e.g. by suction nozzles. New products are supplied onto the turntable 11 by the delivery belt 22 until the level sensor 23 gives the signal that enough products are arranged on the turntable 11. Then product supply by the delivery belt 22 stops. As soon as the level sensor 23 or other monitoring elements again detect gaps on the turntable 11 in the region of the product feed region 20 and/or product removal region 21, the delivery belt 22 is set in operation again. Alternatively or cumulatively, additional monitoring elements, e.g. sensors or the like, can also monitor the product removal region 21 or whether it is occupied in order, in case of a gap or product-free region, to pass on this information to the effect that more products are conveyed into the product feed region 20 and hence finally also into the product removal region 21.

In the event that the product size changes, the guide element 15 is adjusted so that the product removal region 21 is enlarged, namely widened, by moving the rotary shaft 16 of the guide element 15 closer to the rotary shaft 12 of the turntable 11. Adjustment can also be carried out by exchanging the guide element 15 for one with a smaller or larger diameter.

Preferably, it is ensured that the products drop into the product feed region 20 only. This is, for example, achieved by the fact that the delivery belt 22 stops over the product removal region 21 or extends into it and the products drop into the product feed region 20 via guide elements, e.g. chutes or the like.

1.-8. (canceled)

9. Delivery element for delivering a plurality of unsorted products to a subsequent apparatus, in particular an apparatus for separating the products, including a rotatably driveable turntable with which is associated a guide element arranged eccentrically to the turntable, wherein the guide element comprises a side wall which runs approximately parallel to a radially peripheral side wall extending perpendicularly from the turntable, both the turntable and the guide element being driven optionally in the same or opposite directions.

10. Delivery element according to claim 9, wherein the guide element is mounted rotatably driveable on a stationary support.

11. Delivery element according to claim 9, wherein the guide element is adjustably attached to the support.

12. Delivery element according to claim 9, wherein the guide element divides the turntable into a product feed region and a product removal region.

13. Delivery element according to claim 12, wherein in the region of the product feed region is arranged a level sensor.

14. Delivery element according to claim 9, wherein the rotary shaft of the turntable and the rotary shaft of the guide element run parallel to and offset from each other.

15. Delivery element according to claim 10, wherein the guide element is adjustably attached to the support.

16. Delivery element according to claim 10, wherein the guide element divides the turntable into a product feed region and a product removal region.

17. Delivery element according to claim 11, wherein the guide element divides the turntable into a product feed region and a product removal region.

18. Delivery element according to claim 10, wherein the rotary shaft of the turntable and the rotary shaft of the guide element run parallel to and offset from each other.

19. Delivery element according to claim 11, wherein the rotary shaft of the turntable and the rotary shaft of the guide element run parallel to and offset from each other.

20. Delivery element according to claim 12, wherein the rotary shaft of the turntable and the rotary shaft of the guide element run parallel to and offset from each other.

21. Delivery element according to claim 13, wherein the rotary shaft of the turntable and the rotary shaft of the guide element run parallel to and offset from each other.
